(19) United States
(12) Patent Application Publication
(10) Pub. No.: US 2009/0237646 A1
(43) Pub. Date: Sep. 24, 2009

(54) Lyman-alpha Scatterometry

(75) Inventor: Daniel G. Smith, Oro Valley, AZ (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/404,190

(22) Filed: Mar. 13, 2009

Related U.S. Application Data
(60) Provisional application No. 61/038,029, filed on Mar. 19, 2008.

(51) Int. Cl. G01B 11/24; G01N 21/55

(52) U.S. Cl. 356/51; 356/601

(57) ABSTRACT

New and useful optical structure and method are provided, for analyzing the surface topography of a sample. Specifically, an optical system and method are provided in which radiation reflected from a sample is used to determine surface topography characteristics of the sample, and in which an illumination source directs Lyman-α radiation at the sample in an environment that is at least partly an atmospheric environment. Thus, the present invention takes advantage of atmospheric transmission capability at the short wavelength Lyman-α line to provide a system and method that can detect relatively fine surface topography of a sample such as a wafer that has been imaged by a lithographic imaging optical system.

### RELATED APPLICATION/CLAIM OF PRIORITY

This application is related to and claims priority from provisional application Ser. No. 61/038,029, filed Mar. 19, 2008, which provisional application is incorporated by reference herein.

### BACKGROUND

The Hydrogen Lyman-α radiation line light at the wavelength of 121.6 nm is normally considered to be within the VUV (vacuum ultra-violet) band. However, this wavelength is particularly convenient for optical applications because it has substantial atmospheric transmission.

Scatterometry is a technique used to determine characteristics of a surface topography from scattered light. In a typical ellipsometer, a beam of light with certain characteristics, e.g., predetermined wavelength and polarization, is directed with a predetermined angle of incidence to a surface under investigation. The resulting reflected light (which may be scattered light) is then directed through a wave plate and an analyzer and then finally directed to a detector.

As surface topographies (i.e. lines and spaces) get finer and more detailed, the ability to analyze those finer surface topographies becomes more important. At those finer surface topographies, it is common to analyze the surface topographies in ways (e.g. with scanning electron microscopes) that effectively involves destructive testing of the wafer. With the present invention, using illumination with a very short wavelength (121.6 nm), and operating in an environment that is at least partially atmospheric, allows for analyzing the finer details of the wafer topographies in a non destructive manner. Moreover, using illumination at the Lyman-α line allows access to higher order diffracted light that would otherwise be evanescent with visible light illumination.

### SUMMARY OF THE PRESENT INVENTION

The present invention provides a new and useful optical structure and method for employing scatterometry principles to analyze the surface topography of a sample.

In one aspect of the present invention, an optical system is provided in which radiation reflected from a sample is used to determine surface topography characteristics of the sample, and in which an illumination source directs Lyman-α radiation at the sample in an environment that is at least partly an atmospheric environment.

In another aspect of the present invention, a method is provided for producing information related to the surface topography of a sample under investigation. Radiation at the Lyman-α line is directed at a sample under investigation; radiation reflected from the sample is detected, and used to provide information related to surface topography characteristics of the sample. The radiation directed at and reflected from the sample comprises Lyman-α radiation in an environment that is at least partly an atmospheric environment.

The invention takes advantage of the capability of radiation at the Lyman-α line to be transmitted at least partially in an atmospheric environment. The radiation at the Lyman-α line enables relatively fine features of the sample topography to be analyzed, in a manner that does not require enclosing the specimen in a vacuum environment, and also in a manner that does not require destructive testing of the sample. Also, as noted above, using illumination with a very short wavelength (121.6 nm), and operating in an environment that is at least partially atmospheric, allows for analyzing the finer details of the wafer topographies in a non destructive manner. Moreover, using illumination at the Lyman-α line allows access to higher order diffracted light that would otherwise be evanescent with visible light illumination.

The principles of the present invention can be practiced with a sample whose surface can be a three-dimensional monolithic structure, and which can also be a layered structure.

Further aspects of the present invention will become apparent from the following detailed description and the accompanying drawings.

### BRIEF DESCRIPTION OF THE DRAWINGS

FIG. 1 is a schematic illustration of an imaging optical system with which the detection system and method concepts of the present invention can be used; and

FIG. 2 is a schematic illustration of how the principles of the detection system and method of the present invention can be implemented in connection with a sample produced by the imaging optical system principles of FIG. 1.

### DETAILED DESCRIPTION

As described above, the present invention relates to an optical detection system and method for providing information regarding the surface topography of a sample. The principles of the present invention are described herein in connection with a sample that can comprise e.g. a wafer that is imaged (printed) by a lithographic imaging optical system, and from that description the manner in which the principles of the present invention can be implemented in with various types of samples produced by various imaging techniques will be apparent to those in the art.

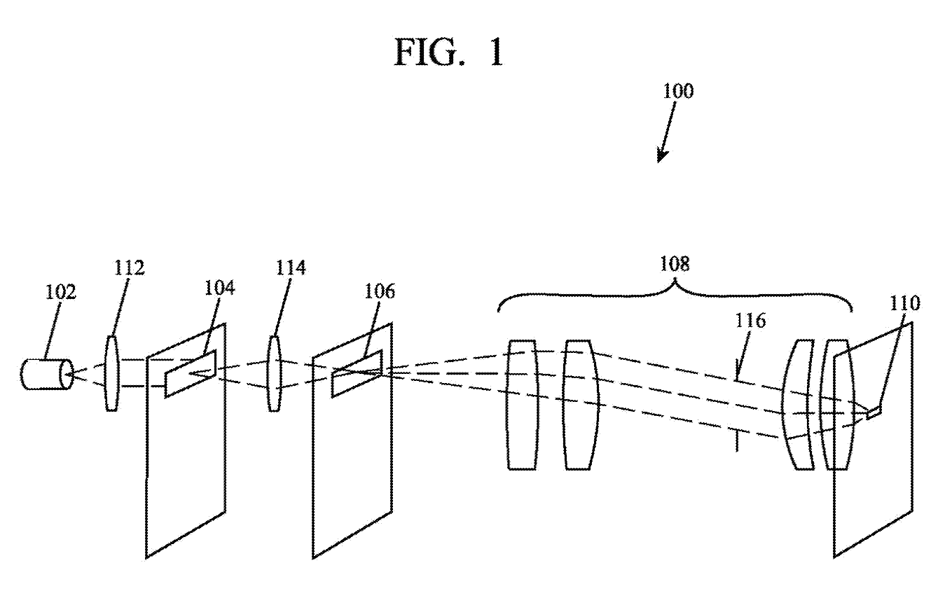

FIG. 1 schematically illustrates an imaging optical system 100 of the type that would be useful in a lithographic imaging optical system. The imaging optical system 100 comprises a radiation (e.g. light) source 102, a scanning slit 104 that is used to direct a scanning beam through an object (or reticle) 106, and primary imaging optics 108 that image the scanned object onto an image plane 110. In a lithographic imaging optical system, the image plane would be at or close to the surface of a wafer that is being imaged (printed) by the lithographic imaging optical system. Such aspects of a lithographic imaging optical system are well known and should not require further description to those in the art. The system 100 also includes illumination optics 112, 114 and a pupil 116 that would be well known to those in the art, and should not require further explanation.

When the wafer is imaged (printed), its three dimensional topography is produced, desirably to conform to a predetermined topography. During production of wafers with predetermined topography, it is important to periodically check the wafer topography, to determine if it is within an acceptable range. It is well known to do that by techniques (e.g. using a scanning electron microscope) whereby a sample wafer is effectively destroyed as its surface topography is analyzed. As imaging of wafers requires finer image details (e.g. in the lines and spaces that form parts of the wafer surface topography) and improved imaging quality, the need for analyzing finer details of the surface topography of a wafer becomes more important. The structure and method of the present invention address this issue directly, by using VUV radiation that can detect finer wafer image details, and in an environment that is at least partially exposed to atmosphere, and therefore leads to efficient and non destructive testing of the wafer.

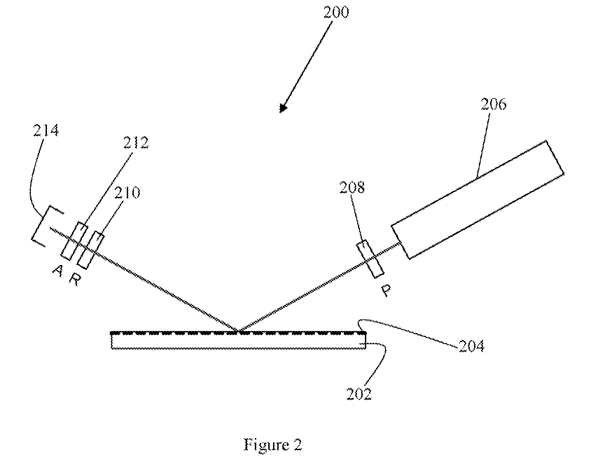

FIG. 2 schematically illustrates structure and method by which the surface topography of a sample such as a wafer that has been imaged by a lithographic imaging optical system can be analyzed, according to the principles of the present invention. The analysis system set up is shown at 200, and comprises the wafer 202 with three dimensional surface topography schematically shown by the dashed lines 204. Radiation at the Lyman-α line (121.6 nm wavelength) is produced from a source 206, which may comprise, e.g. a lamp that produces the radiation at the Lyman-α line and one or more optics, typically reflectors, that shape the radiation beam produced from the source 206. The Lyman-α radiation produced from source 206 is directed at the sample 202 through a polarizer 208, the light is reflected from the surface of the sample 202, and the reflected light is passed through a retarder 210 and an analyzer 212 before reaching the detector 214. This type of system set up is commonly used in scatterometry, and should not require further explanation to those in the art.

The reflected radiation at the Lyman-α line is detected, and used to provide information related to surface topography characteristics of the sample 202. Specifically, the detected radiation can be compared to reference data to determine whether surface topography of the wafer is within an acceptable range. The manner in which surface topography is analyzed is described further below.

In an important aspect of the present invention, the radiation directed at and reflected from the sample 202 comprises Lyman-α radiation in an environment that is at least partly an atmospheric environment. Thus, while the generation of Lyman-α radiation within the source 206 desirably takes place in an atmosphere that is free from oxygen (which might affect the level of radiation directed from the source), the transmission of the radiation between the source 206 and the sample 202, and between the sample and the detector 214, takes place in an atmospheric environment. Moreover, there is no physical contact of any testing equipment with the sample, so the system of FIG. 2 is non destructive regarding the sample 202.

In the system and method illustrated in FIG. 2 the detected signal for various polarizations, wavelengths and angles of incidence would depend on the structure of the sample, but in a very non-linear way. Initially, in determining the surface topography from the measured reflection a physical model is constructed of the entire system and the detected reflection signal is simulated. This is known as the forward problem, and is generally done using one of the modern electromagnetic field solving techniques like rigorous coupled wave analysis (RCWA) or finite difference time domain (FDTD).

The surface topography of the sample under investigation is typically described in terms of a number of parameters, and the eventual goal in scatterometry is to estimate the values of those parameters from the measurements at the detector. This is known as the reverse problem, and there are two basic approaches. Either the parameters in the model are adjusted to minimize some merit function involving simulated and measured values using some type of minimum seeking optimization like Leuenberg-Marquardt or by use of a look up table based on previously simulated results.

A particular advantage of this invention is that using illumination with such a short wavelength (121.6 nm) should allow for more sensitivity to smaller structures, and also access to higher order diffracted light that would otherwise be evanescent with visible light illumination. All of this is conveniently enabled by the choice of wavelength, since the radiation can be readily generated with a Hydrogen Lyman-α source, and since this atmosphere is relatively transmissive at this wavelength.

Thus, applicant has described herein an optical system and method in which radiation reflected from a sample is used to determine surface topography characteristics of the sample, and in which an illumination source directs Lyman-α radiation at the sample in an environment that is at least partly an atmospheric environment. With the foregoing description in mind, the manner in which the principles of the present invention can be used to analyze surface topography of various structures will be apparent to those in the art.

1. An optical system in which radiation reflected from a sample is used to determine surface topography characteristics of the sample, and in which an illumination source directs Lyman-α radiation at the sample in an environment that is at least partly an atmospheric environment.

2. A method of providing information related to the surface topography of a sample under investigation, comprising directing radiation at a sample under investigation, detecting radiation reflected from the sample, and using the detected radiation used to provide information related to surface topography characteristics of the sample, wherein the radiation directed at and reflected from the sample comprises Lyman-α radiation in an environment that is at least partly an atmospheric environment.
